(19) United States
(12) Patent Application Publication
(10) Pub. No.: US 2002/0145310 A1
(43) Pub. Date: Oct. 10, 2002

(54) Openable motor vehicle roof with two transparent covers

(75) Inventors: Walter Schatzler, Starnberg (DE); Manfred Pfalzgraf, Herrsching (DE)

Correspondence Address: NIXON PEABODY, LLP, 8180 GREENSBORO DRIVE, SUITE 800, MCLEAN, VA, 22102, US

(73) Assignee: Webasto Vehicle Systems International GmbH, Stockdorf (DE)

(21) Appl. No.: 10/085,136

(22) Filed: Mar. 1, 2002

(30) Foreign Application Priority Data
Mar. 1, 2001 (DE) 101 10 013.2

(51) Int. Cl. B60J 7/04

(52) U.S. Cl. 296/214

(57) ABSTRACT

An openable motor vehicle roof with a first (10) and a second transparent cover (12) which, in the closed position, each close a roof opening and are displaceable in order to clear the roof opening at least in part. Underneath the first cover, there is a first covering (15) and underneath the second cover there is a second covering (21), the coverings being movable to mask or at least partially clear the view out of the vehicle interior (28) through the respective cover or roof opening. For the displacement of the first cover (10) and at least partial displacement of the first covering (15), there is a common first drive (30, 32), and for displacement of the second cover (12) and for at least partial adjustment of the second covering (21), there is a common second drive (34, 36, 38, 40).

### BACKGROUND OF THE INVENTION

1. Field of the Invention

This invention relates to an openable roof with first and second transparent covers, each of which close a roof opening in the closed position and are displaceable, in order to clear the roof opening at least in part, there being first and second covering means underneath the first and second covers, respectively, which covering means are displaceable in order to mask or at least partially clear the view out of the vehicle interior relative to the respective cover or roof opening.

2. Description of Related Art

A motor vehicle roof of the initially mentioned type is known, for example, from German Utility Model DE 297 23 662 U1, where there is a shade which can be manually adjusted under each of two movable or raisable covers which are located offset in succession in the lengthwise direction of the roof. The roof openings to be closed by the covers are separated from one another by a center crosspiece, in the area of which the winding shafts of the shades can be located. In an alternative embodiment of this known motor vehicle roof, also at least one of the shades can be actuated by an electric motor. However, no details regarding the configuration and number of drives for the covers and the shade or shades are disclosed.

German Patent DE 197 50 715 C1 discloses a motor vehicle roof in which there is one adjustable transparent cover and one fixed transparent cover, to which one separate shade at a time is assigned. The two shades are adjusted by a common drive via a drive cable which entrains the draw bar of the shade in the roll-up direction.

German Patent DE 195 00 367 C1 and corresponding U.S. Pat. No. 5,709,427 disclose a motor vehicle roof in which a single cover and a single shade are provided which are driven by two separate drives.

European Patent EP 0 150 470 B1 and corresponding U.S. Pat. No. 4,671,654 disclose a motor vehicle roof with a single cover and a single sliding headliner in which the cover can be raised by means of a drive which use a compressively stiff drive cable. When the cover is raised, by moving the free end of the drive cable via a driver means, the sliding headliner is opened a distance in order to enable good air exchange in the raised position of the cover. Otherwise, the sliding headliner is manually actuated.

European Patent EP 0 185 193 B1 discloses a motor vehicle roof with a single cover and a single sliding headliner, and the cover can be raised by means of a drive which comprises a compressively stiff drive cable which engages a slider for the cover. The slider is provided with a rack which, when the cover is raised, engages and drives a gear arrangement which, for its part, engages the rack which is made on the sliding headliner which is in the closed position. In this way, when the cover is raised, the sliding headliner is opened a distance out of the closed position. The gear arrangement can be provided with a catch coupling in order to enable manual displacement of the sliding headliner even with the cover raised. In the closed position of the cover, the sliding headliner can be freely moved manually anyway. The cover can be pushed farther to the rear in order to clear the roof opening, there being a driver to entrain the sliding headliner during its movement to the rear.

German Patent DE 199 10 839 C1 discloses a shade arrangement for a motor vehicle roof, the free end of the shade web being connected to the winding shaft for the shade web by means of a cable which is guided via deflection rollers. The winding shaft can be manually or electrically actuated.

### SUMMARY OF THE INVENTION

The primary objects of this invention are to devise a motor vehicle roof with a large roof opening surface which can be cleared, and light incidence through the roof opening surface can be varied with control as simple as possible and to enable the adjustment and drive mechanism of the motor vehicle roof will be made as simple as possible.

These objects are achieved in accordance with the invention by a motor vehicle roof as described below.

In accordance a first approach, it is advantageous that only two drives are necessary and the two covers can be adjusted independently of one another and at least partially automatic adjustment of the covering means is possible. In this way, installation space and costs can be saved without overly adversely affecting the ease of operation.

According to another approach, it is advantageous that only two drives are necessary and both the covers and also the covering means can be automatically adjusted.

The invention is described in detail below with reference to the accompanying drawings.

### BRIEF DESCRIPTION OF THE DRAWINGS

FIGS. 1 to 6 schematically show a side view of a first embodiment of a motor vehicle roof in accordance with the invention in respective different positions of the covers and coverings;

FIGS. 7 to 13 show views similar to those of FIGS. 1 to 6, but of a second embodiment of the motor vehicle roof,

FIGS. 14 to 18 show views similar to those of FIGS. 1 to 6, but of a third embodiment of the motor vehicle roof,

FIGS. 19 to 21 are plan views of a motor vehicle roof according to the embodiment of FIGS. 7 to 13, different positions being shown;

FIG. 22 shows the raising mechanism for the right hand side of rear panel as seen from inside the roof;

FIG. 23 shows the raising mechanism for the right hand side of the rear cover as seen from the outer side of the roof;

FIG. 24 shows the raising mechanism according to FIG. 22 in its position corresponding to the closed position of the rear panel;

FIG. 25 shows the position of the raising mechanism in which the rear panel in its upwardly inclined position according to FIG. 23.

FIG. 26 is a cross section of FIG. 24 illustrating the guiding of the drive cable within the guide rail;

FIG. 27 is a top view illustrating the simultaneous engagement of the ends of a drive cable for moving the front cover;

FIG. 28 is a top view corresponding to that of FIG. 27, but showing the roof in the position according to FIG. 3;

FIG. 29 is a top view corresponding to that of FIG. 27, but showing the roof in the position according to FIG. 2;

FIGS. 30A-D show an alternative embodiment displacement mechanism in different positions; and

FIG. 31 is an enlarged view of FIG. 30A.

### DETAILED DESCRIPTION OF THE INVENTION

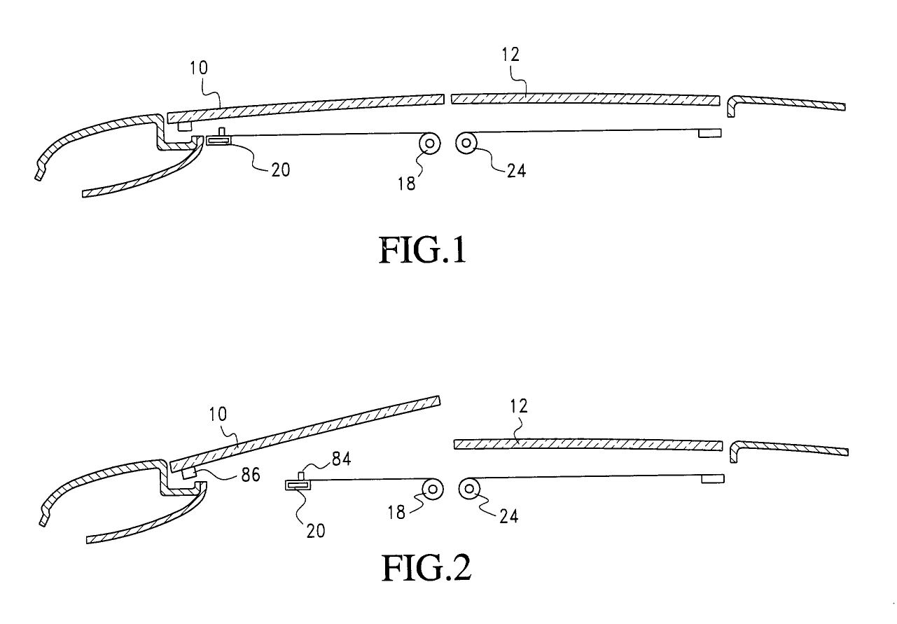

As shown in FIGS. 1 to 6, the motor vehicle roof according to the first embodiment comprises two covers 10, 12 which are located in succession, one behind the other, in the closed position (FIG. 1). In the closed position, the covers 10, 12 close either a common roof opening or two roof openings that are separated by a middle crosspiece in the fixed roof skin 14. Underneath the front cover 10 is a front shade 15 which comprises a shade web 16 which can be wound onto a winding shaft 18 which runs in the transverse direction of the roof and which is located in the area of the back end of the front cover 10. On the free end of the shade web 16 is the draw bar 20. Similarly, underneath the rear cover 12 is a rear shade 21 with a shade web 22, the winding shaft 24 being located adjacent and parallel to the winding shaft 18 of the front shade 15. The free, i.e., the back end of the shade web 22 is provided with a draw bar 26. The two covers 10, 12 are made of a transparent material, preferably as glass or plastic covers. The front shade 15 and the rear shade 21 are intended to at least partially cover the covers 10, 12 and the roof opening, if necessary in order to prevent excess incidence of sunlight into the motor vehicle interior 28.

The front shade 15 and the rear shade 21 are made (preferably, as in the above mentioned German Patent DE 199 10 830 C1) as a shade with deflection rollers, a shade bar on each side being engaged by a cable which runs via the corresponding deflection rollers toward the lateral edge area of a winding shaft, where is it wound and unwound. This execution of the shade has the advantage that the combination of the shade web and cables is in a force-balanced equilibrium, and thus, opposes a constant counter-force to displacement.

In the closed position shown in FIG. 1, the front shade 15 can be moved manually in order to undertake the desired regulation of incident solar radiation through the front cover 10.

The front cover 10 can be raised at its rear edge by means of a drive assigned to it, on the one hand, by means of a corresponding raising mechanism, and on the other hand, can be moved to the rear to under the rear cover 12, this likewise taking place by means of the assigned drive. The drive for the front cover 10, conventionally, comprises at least one and preferably two compressively stiff drive cables which are driven via a pinion by an electric motor and each engage the slider of the cover adjustment mechanism.

FIG. 2 shows the position in which the front cover 10 has been moved into the raised position by means of the assigned drive, i.e., with the rear edge of the cover raised. The drive is made such that, in this raising motion, the front shade 15 is opened at least some distance automatically, as is shown in FIG. 2, in order to enable sufficient air flow through the roof opening which has been partially cleared in this way. The drive mechanism can be made here, for example, as in U.S. Pat. No. 4,671,564, where the free end of each drive cable moves the bar 20 of the front shade 15 to the rear by a driver means when the front cover 10 is being raised.

Alternatively, the drive mechanism can be made as in EP 0 185 993 B1, where the slider of the raising mechanism which is engaged by the respective drive cable is provided laterally with a rack which, in the raising process, engages the gear arrangement which is mounted on the roof and drives it to rotary motion, the gear arrangement in turn being engaged to a rack which is located laterally in the area of the shade bar 20, and in this way, moves the shade bar 20 of the front shade a distance to the rear into the partially open position which is shown in FIG. 2.

In both cases, the front shade 15 and the shade bar 20 are blocked against a closing motion, as long as the front cover 10 is raised.

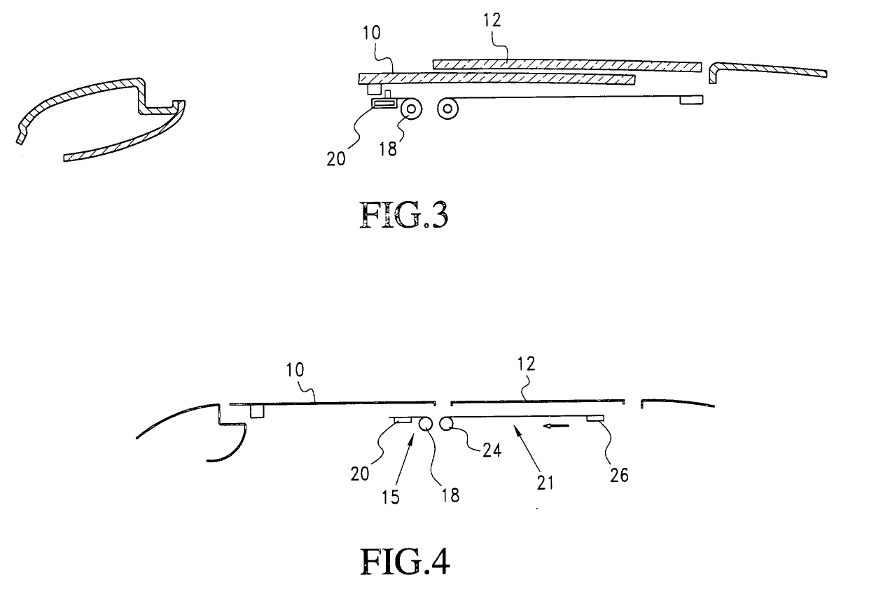

The front cover 10 can be moved out of the position shown in FIG. 2 by lowering the rear edge again into the closed position shown in FIG. 1, and depending on the execution of the drive mechanism, the shade bar 20 can be automatically entrained forward in order to close the shade 15 again. From the closed position shown in FIG. 1, the cover 10 can be pushed to the rear to under the cover 12 by slightly lowering its rear edge until the position shown in FIG. 3 has been reached. In this opening displacement motion of the cover 10, it entrains the shade bar 20, and thus, the shade web 16 of the front shade 15, to the rear via a correspondingly executed driver means, as is known, for example, from European Patent EP 0 185 993 B1, until the shade 15 is likewise completely opened.

When the front cover 10 is to be closed, the described process proceeds in reverse, i.e., the front cover 10 entrains the shade bar 20 forward into the closed position via the driver means.

The described embodiment of the drive which is assigned to the front cover 10 makes it possible to functionally adjust the front shade 15 at least in part automatically according to the cover position, especially for a certain cover opening, the corresponding opening of the shade taking place. Compared to a purely manually actuated shade, this increases the ease of operation without an additional drive being necessary for the shade.

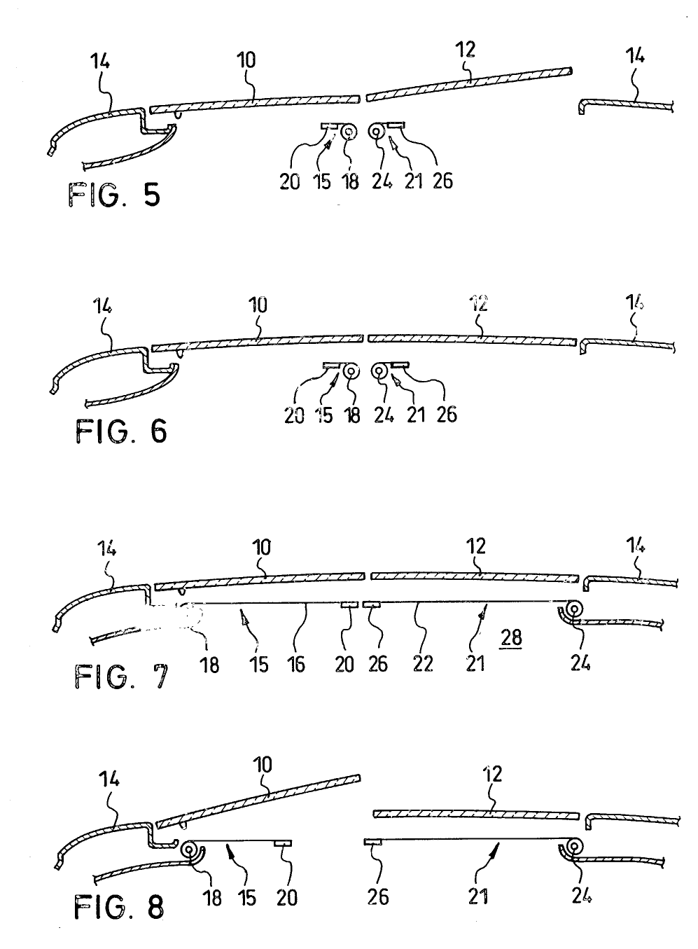

The rear cover 12 is provided only with a raising function, but not with a sliding function and is driven by a second drive which likewise preferably comprises an electric motor which drives a pinion and two compressively stiff drive cables which are driven by the pinion and which engage the slider of the cover mechanism. FIG. 4 shows the position in which the front cover 10 and the rear cover 12 are closed, while the front shade 15 is being opened and the rear shade 21 is being opened forward by means of the drive which is assigned to the rear cover 12. Here, there is a driver on the driven slider which entrains the shade bar 26 of the rear shade 21. Before the rear shade 21 is completely opened, the drive motion of the slider still does not cause actuation of the raising mechanism of the rear cover 12. When complete opening of the rear shade 21 is achieved, the slider automatically releases with respect to the shade bar 26, its being locked in the open position by means of a locking block. Then, the slider engages the raising mechanism of the rear cover 12 which, until then, had been locked with the locking block and causes a raising motion of the rear cover 12, its rear edge being raised, see FIG. 5. When the cover 12 has been lowered out of this position again into its closed position, the slider releases from the raising mechanism of the cover 12, locking of the cover 12 being accomplished by the locking block. Then, the slider again engages the shade bar 26, by which it is unlocked and is entrained to a closing motion, see FIG. 6.

In the described embodiment of the drive assigned to the rear cover 12, by providing only a common drive, the rear cover 12 and the rear shade 21 can be comfortably adjusted entirely by motor without an additional drive being necessary; this enables savings mainly with respect to installation space and costs. When the rear cover 12 is closed, the shade 21 can be adjusted by motor in any manner by actuating the drive. The rear cover 12 can only be raised when the shade 21 has been completely opened beforehand.

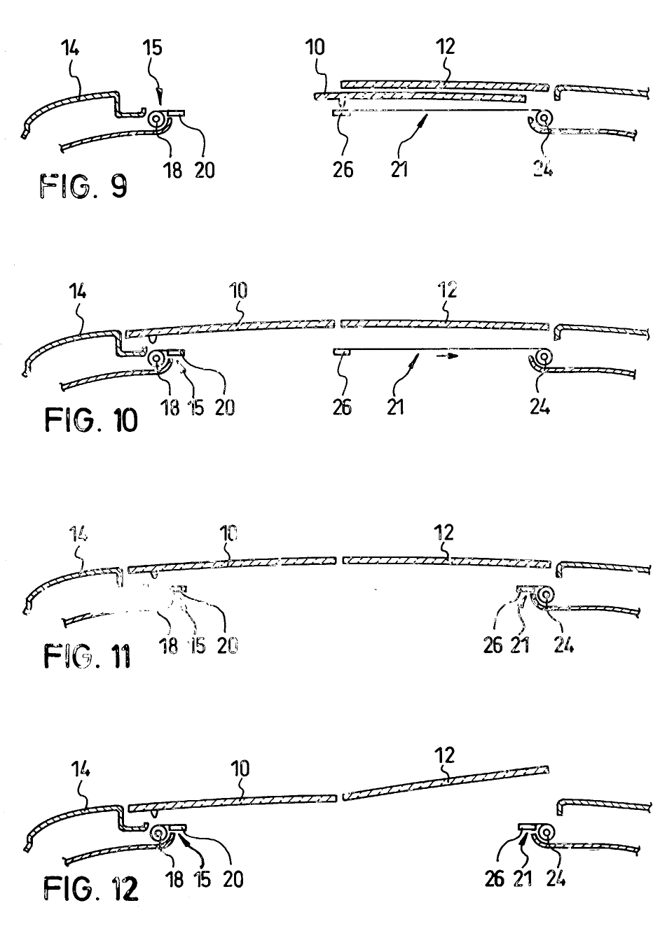

FIGS. 7 to 13 show a modified embodiment of the motor vehicle roof, the major difference being that the winding shafts 18, 24 of the front shade 15 and of the rear shade 21 are not located in the middle area of the roof between the two covers 10, 12, but in the front end area of the front cover 10 or in the rear end area of the rear cover 12. The functionality or actuation of the motor vehicle roof, aside from this difference which leads to reversal of the opening and closing direction of the shades 15, 21, is the same as in the embodiment as shown in FIGS. 1 to 6.

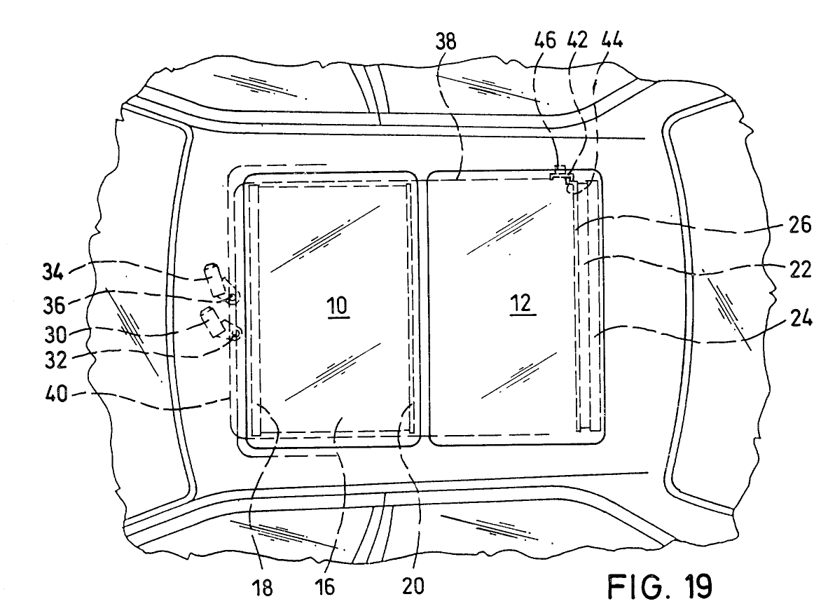

FIGS. 19 to 21 show different positions of the drive for the rear cover and the rear shade in an aspect. As shown in FIGS. 19 to 21, in the front end area of the roof the two drives for the front cover 10 and the rear cover 12 are located, the drive for the front cover 10 comprising a drive motor 30 with a pinion 32 and two drive cables which are not shown, and the drive for the rear cover 12 encompassing a motor 34 located next to it with a pinion 36 and two compressively stiff drive cables 38 and 40.

As shown in FIG. 19, one end of the drive cable 38 engages the slider 42 which is movably guided in the lengthwise direction of the roof and which, in the position shown in FIG. 19, is coupled via a driver 46 to the raising mechanism of the rear cover 12 and has moved it into the raised position shown in FIG. 12. The rear shade 21 is completely opened in this position, i.e., the shade bar 26 is located in the vicinity of the winding shaft 24 in the region of the back end of the roof opening.

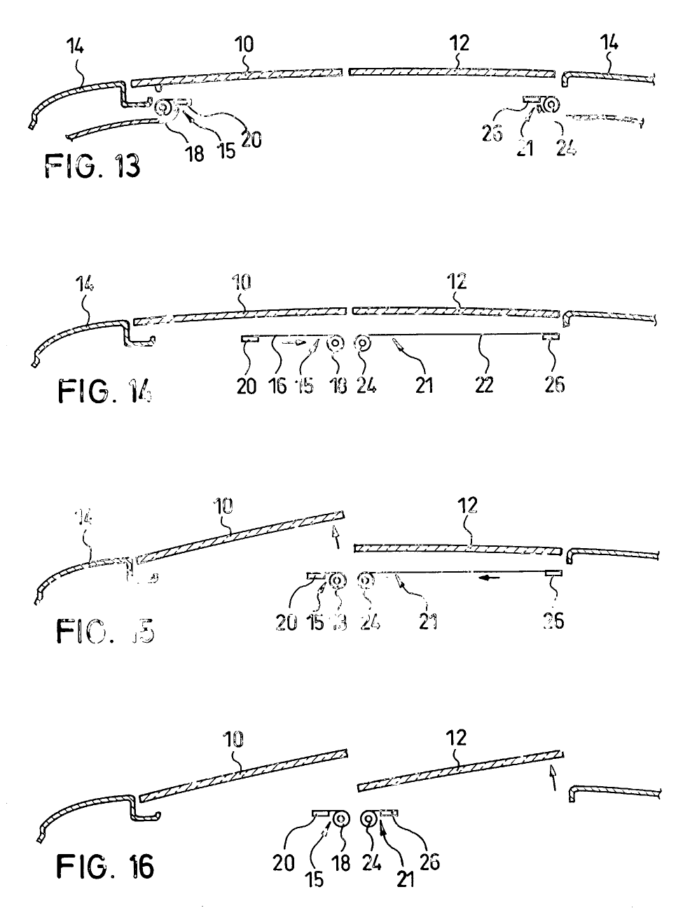

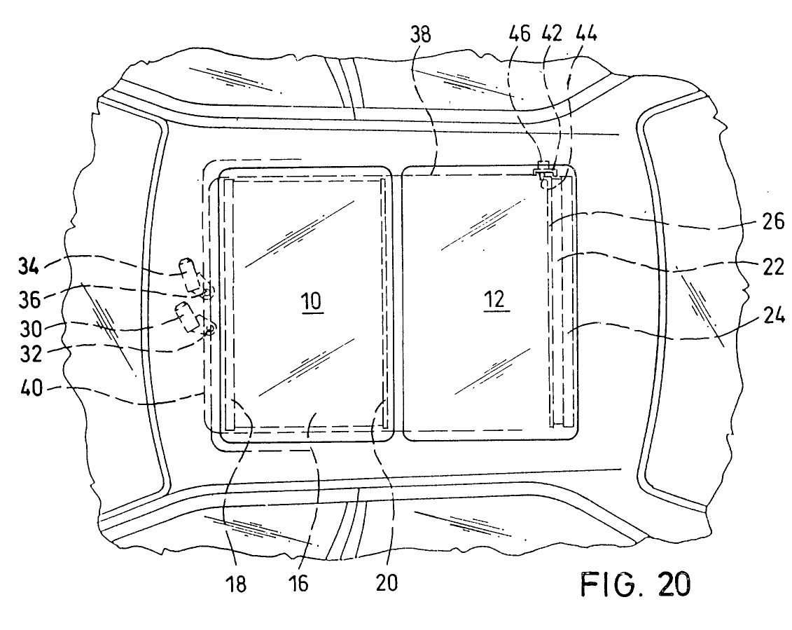

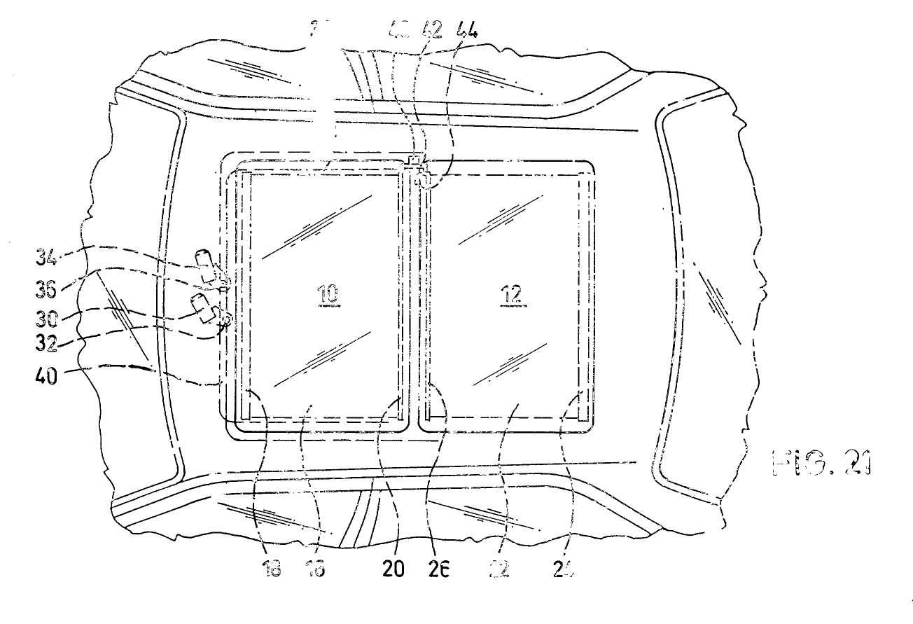

By actuating the motor 34, the drive cable 38 in FIG. 20 is moved forward a distance, by which the cover mechanism has been actuated such that the cover 12 has been moved into the closed position shown in FIG. 13. The slider 42 is now decoupled from the cover mechanism and now fits into a driver 44 which is located laterally on the shade bar 26, by which the shade bar 26 is moved forward to close the shade 21 when the motor 34 is further activated. In doing so, the end position shown in FIG. 21 is reached which corresponds to the closed position of the rear cover 12 and of the rear shade 21 shown in FIGS. 7 to 9. In FIGS. 19 to 21, only the drive cable 38 is shown in detail; the drive cable 40 is however made similarly.

FIGS. 14 to 18 show a third embodiment, here, a common drive being responsible for the two covers 10, 12 and a common drive separate from it being responsible for the two shades 15, 21.

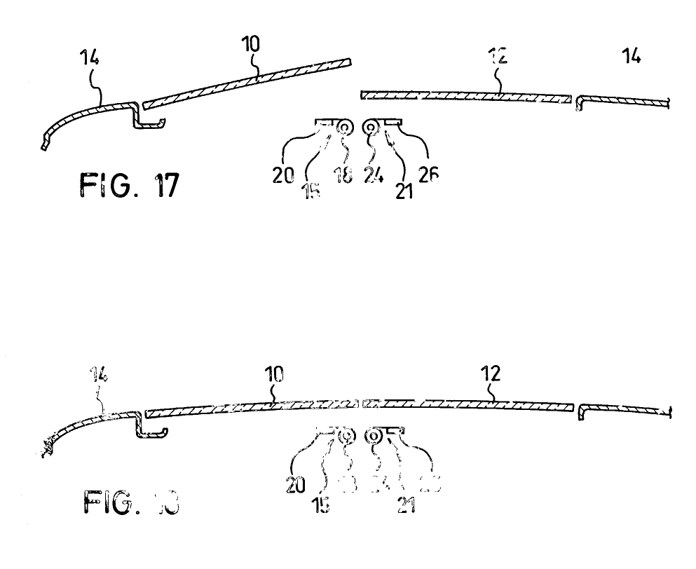

The sequence of opening motions results from the sequence that is shown in FIGS. 14 to 18. Proceeding from the closed position of FIG. 14, by actuating the shade drive, the front shade 15 can be completely or partially opened. As shown in FIG. 15, when the front shade 15 is fully opened, the front cover 10 can be raised. The rear shade 21 can then likewise be completely or partially opened by further actuation of the shade motor. When the rear shade 21 has been completely opened, as shown in FIG. 16, the rear cover 12 can also be raised by actuating the cover drive. Proceeding from this position, by further actuating the cover drive the rear cover 12 can be lowered again, see FIG. 17. Then, the front cover 10 can also be lowered again by actuating the cover drive in order to achieve the position shown in FIG. 18 in which the covers 10, 12 are closed, while the shades 15, 21 are completely opened.

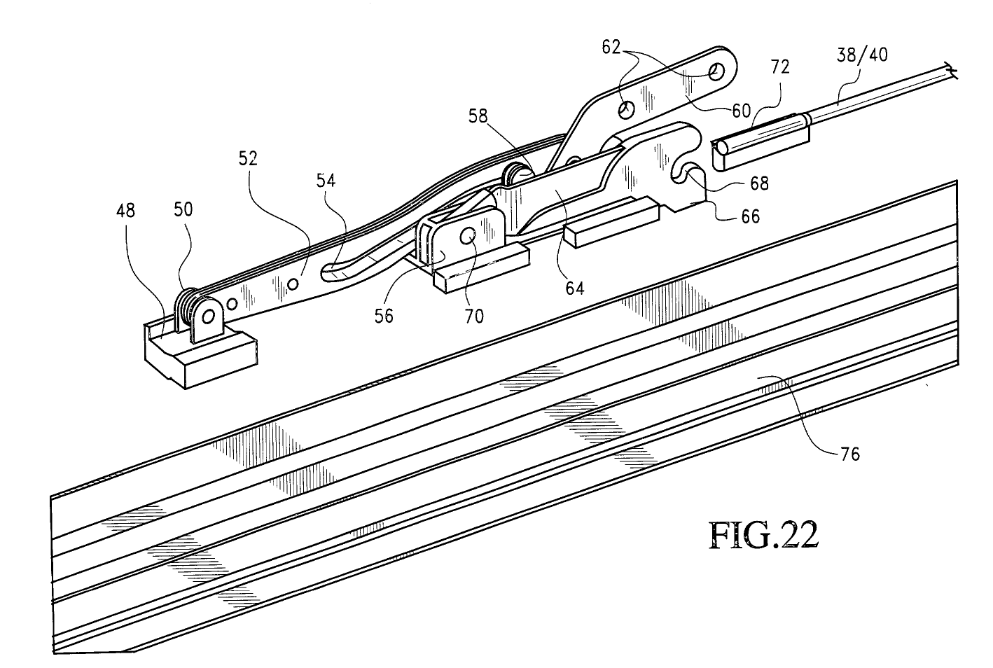

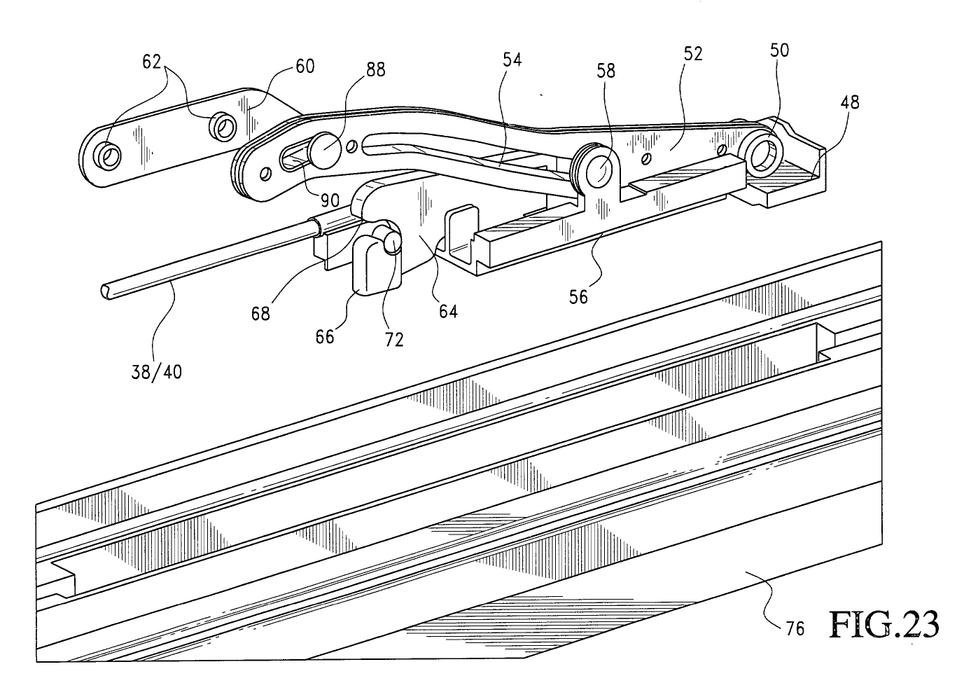

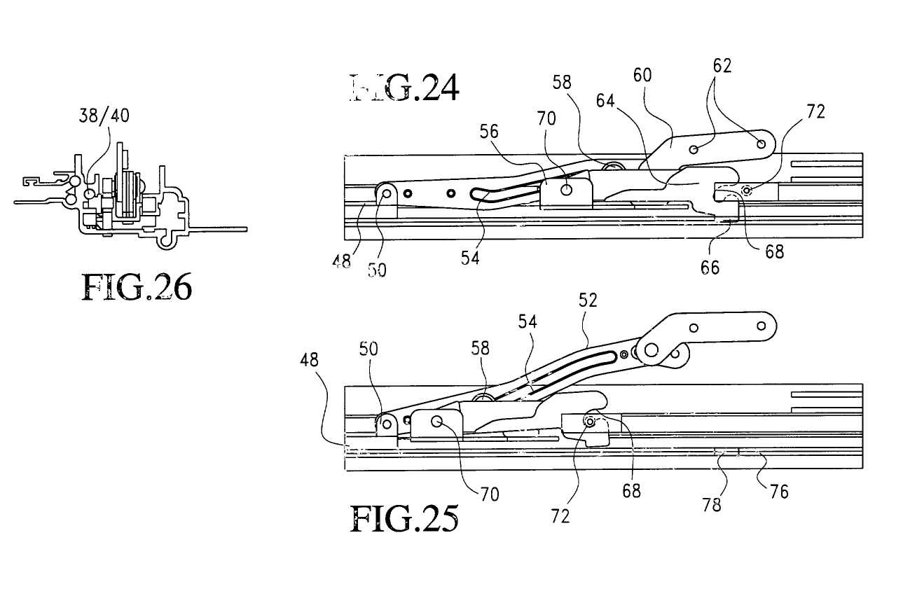

In FIG. 22, the raising mechanism for the right hand side of rear panel 12 is shown with a view from inside the roof. Pivot lever 52 is pivotably journalled about pivot axis 50 at a bearing bracket 48 fixedly joined to guide rail 76. Pivot lever 52 has a guide slot 54 engaged by a pin 58 carried by a slider 56 which is slidably movable along a guide rail 76. Near the end of pivot lever 52, a carrier 60 for rear cover 12 is pivotably linked thereto. Carrier 60 is linked with rear cover 12 by means of by screws or the like passed through holes 62. Slide 56 is also journalled at axis 70 to a locking lever 64 that is equipped at its rear bottom end with a locking block 66 that is engageable in a locking hole 78 provided in the guide rail 76. Locking lever 64 further comprises a lifting coulisse notch 68 near its rear end situated above the locking block 66. The lifting coulisse notch 68 is engaged by a driver 72 mounted at an end of drive cable 38, 40 when this drive cable 38, 40 is pushed forward from the closed position, shown in FIG. 22 or FIG. 24, to the raised or inclined position, represented by FIG. 23 or FIG. 25. Due to the fact that front end of pivot lever 52 is held in its position with regard to the longitudinal direction of guide rail 76 by the fixed bearing bracket 48, engagement of the driver 72 in the lifting coulisse notch 68, on the one hand, raises the rear end of the locking lever 64, thereby disengaging the locking block 66 from the locking hole 78 (see FIGS. 24 & 25), and on the other hand, moves slide 56 to the front, thereby pivoting the pivot lever 52 by engagement of pin 58 in guide slot 54. During this pivoting movement, and preferably also some way before, the opposite end (not shown) of the drive cable 38 or 40 is linked to the bar 26 of the rear shade 21, thus opening the rear shade 21 at least partly before the rear end of the rear cover 12 is swung upward.

In FIG. 23, the same raising mechanism for the rear cover 12 is shown from the outer side of the roof, and in the inclined position instead of in the closed position. As can be seen here, the carrier 60 engages the rear end of the tilting lever 52 by means of a pin 88 engaging an elongated hole 90.

FIG. 24 shows the raising mechanism according to FIG. 22 in its position corresponding to the closed position of the rear panel 12. In this figure, the engagement of locking block 66 in the locking hole 78 of guide rail 76 is illustrated, locking hole 78 being more clearly shown in FIG. 25, which corresponds to FIG. 24, but shows the position of the raising mechanism in which the rear panel 12 in its upwardly inclined position according to FIG. 23.

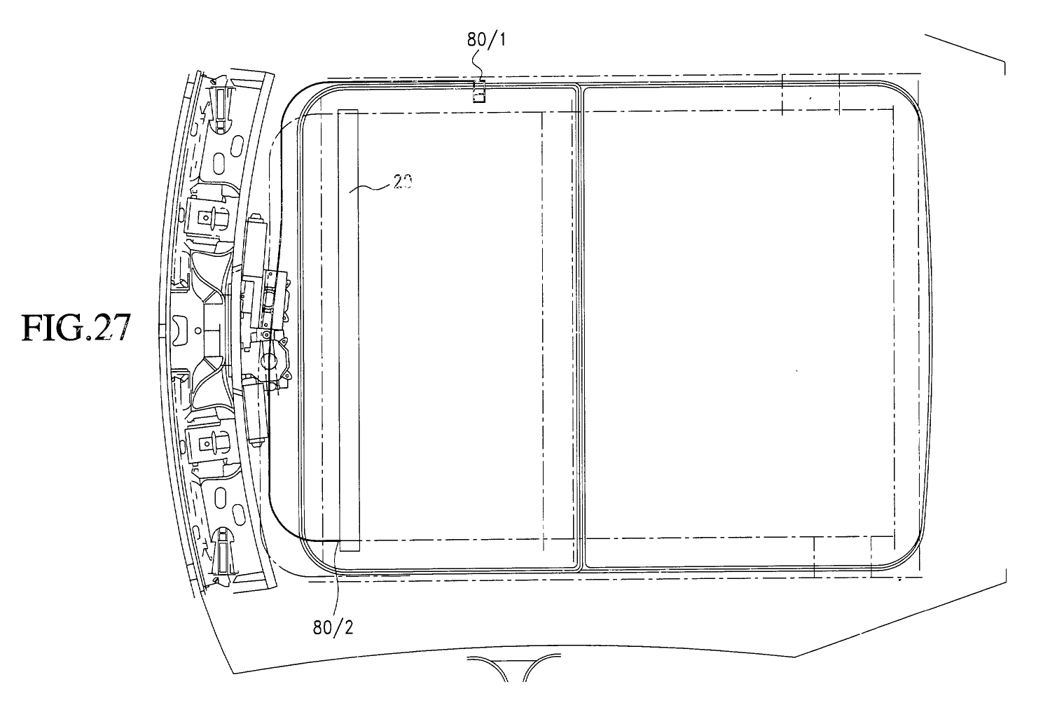

FIG. 26 is a cross section of FIG. 24 illustrating the guiding of drive cable 38, 40 within the guide rail 76, while FIG. 27 is a top view illustrating the simultaneous engagement of the ends 80/1 and 80/2 of a drive cable 80 for moving the front cover 10 by engagement of a coupling member at the end 80/1 of the drive cable 80 and for moving the bar 20 of front shade 15 by engagement of the end 80/2.

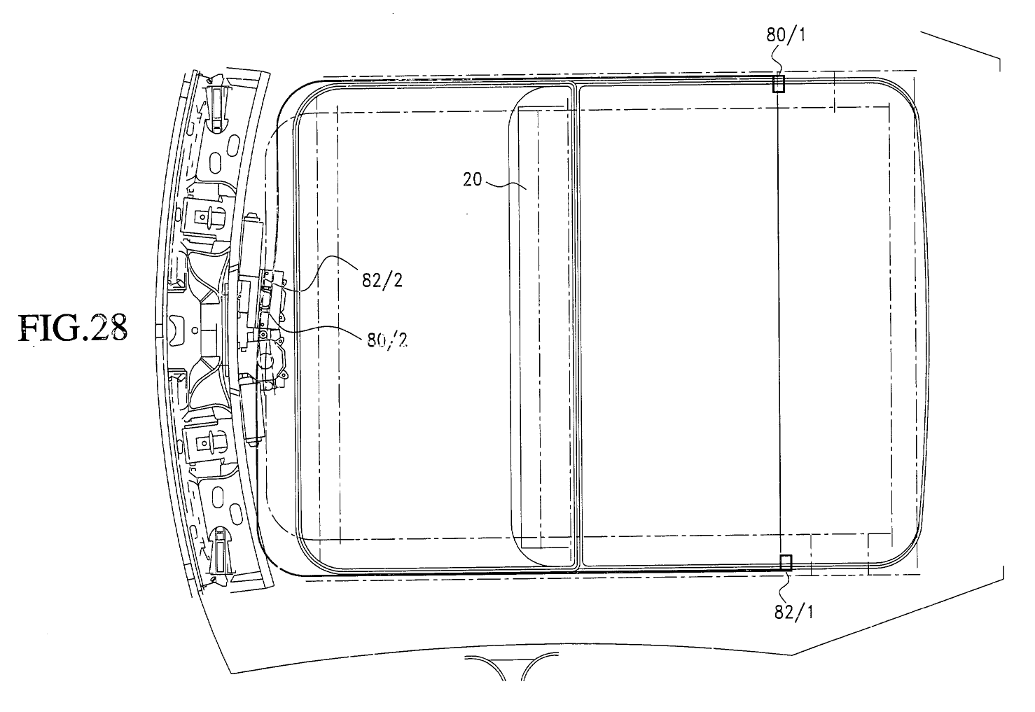

While only one drive cable 80 is shown in FIG. 27, also a second drive cable 82 is shown in FIGS. 28 & 29 which has an engagement means at its end 82/1 that engages the front cover 10 at an opposite side of the cover relative to the engagement means at the end 80/1 and which engages the bar 20 of the front shade 15 with its end 82/2 that is disposed oppositely relative to the end 80/2.

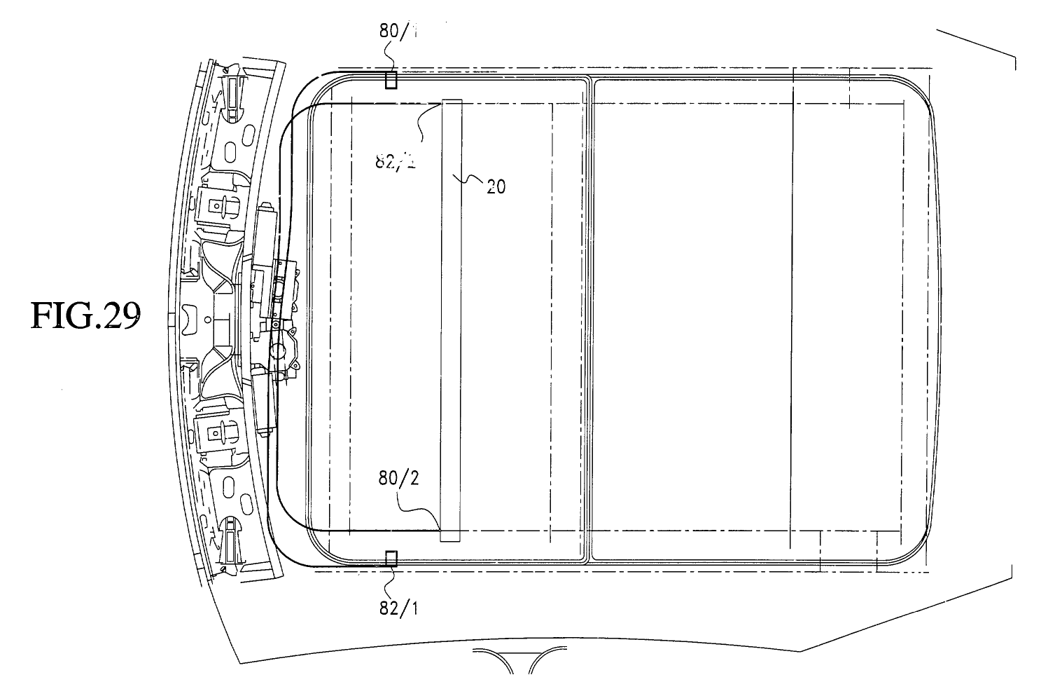

Additionally, as it is disclosed in FIGS. 2 & 3, the bar 20 has a dog 84 located on its top which engages with a dog 86 at the inner side of panel 10, close to the front edge. As can be seen from FIG. 29, the ends 80/2 and 82/2 are active for opening front shade 15 at least partly while front cover 10 is swung upward, but are not active when the cover 10 is moved back according to FIG. 28, where, however, the engagement of the dogs 86 and 84 opens front shade 15. In FIGS. 27 to 29, the drive cables 38, 40 for moving the rear panel 12 and the rear shade 21 have been omitted for clarity sake. One of the drive motors 30 or 34 actuates the front cover 10 and the front shade 15 by the drive cables 80, 82, while the other drive motor 34 or 30 actuates the rear cover 12 and the rear shade 21 by means of the drive cables 38, 40.

The winding shafts 18, 24 are located in the middle roof area as in the embodiment shown in FIGS. 1 to 6, i.e., in the area between the two covers 10, 12.

In contrast to the embodiments shown in FIGS. 1 to 13, the front cover 10 can only be raised, and cannot be moved to under the rear cover 12.

In an alternative embodiment, a displacement mechanism comprised of connecting rods and cooperating self-actuated locking blocks, as disclosed in German Patent Application 100 63 055.3, filed on Dec. 18th, 2000, is used for actuating first a shade member 15 or 21 while an actuating slide for cover 10 or 12 is still locked with the guide rail, and for then actuating the actuating slide (for example, slide 56) of the respective cover 10 or 12 while, simultaneously, a locking block for the actuating slide of the cover is disengaged from the guide rail and is engaged to a connecting rod connected to the drive cable while, at the same time, a locking block disengages the connecting rod from the bar of a shade and engages it to the guide rail 76. This mechanism could also operate two different devices by just one drive in a time offset manner.

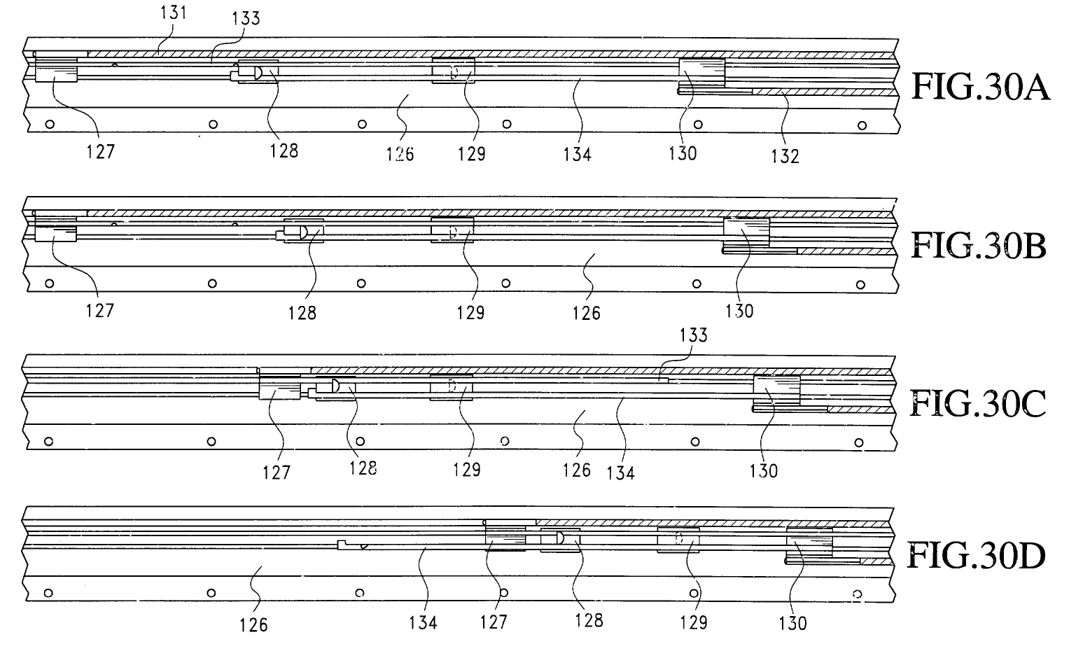

In FIGS. 30 & 31 such an alternative embodiment displacement mechanism is represented. In these figures, front displacement slides 127, 128 are shown that are coupled in the area of the front edge and rear edge of the front cover, respectively, while rear displacement slides 129, 130 are coupled in the area of the front and rear edges of the rear cover, respectively. First and second drive cables 131, 132, which are guided in guide grooves formed in a guide track 126, are fastened to the front displacement slide 127 and the rear displacement slide 130, respectively. A front connecting rod 133 and a rear connecting rod 134 constitute first and second coupling means, the rear connecting rod 134 being fastened at its front end to the front displacement slide 128 and at its rear end to the rear displacement slide 130, while the front displacement slide 127 is fastened to the front end of the front connecting rod 133 and the rear displacement slide 129 is secured to the rear end of the front connecting rod 133.

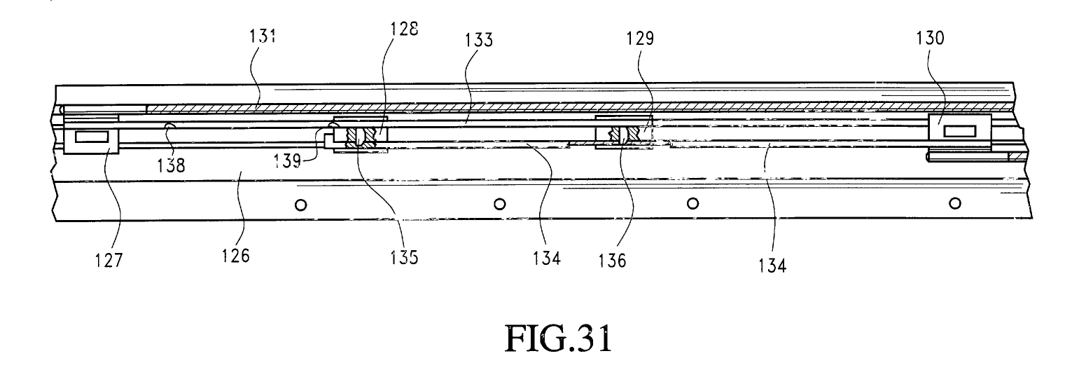

FIG. 30A shows the position in which the front and rear covers 10, 12 are fully closed as in FIG. 1. In this position, the front displacement slide 128 is coupled with the rear connecting rod 133 by the locking block 135 and the rear displacement slide 129 of the rear connecting rod 134 is coupled with the guide track 126 by a locking block 136, thereby securing the covers 10, 12 against movement. The positioning of the locking blocks 135, 136 in this position is shown more clearly in FIG. 31. Movement of the locking blocks 135, 136, out of the guide track is blocked by the connecting rod 133 in this position.

From this position, the front cover can be swung upward into the FIG. 2 by movement of the displacement mechanism to the position shown in FIG. 5B by displacement of drive cable 132. Drive cable 132, acting via the displacement slide 130, draws the connecting rod 134 to the rearward (to right as seen in FIG. 5A), pulling the front displacement slide 128 rearward and causing the raising mechanism coupled thereto to raise the rear edge of the front cover 10. Because the connecting rod 133 is coupled to the guide track 126 via displacement slide 129 and is decoupled from the connecting rod 133, the rear cover remains closed.

By movement of the drive cable 131 rearward, the connecting rod 133 can be moved to bring the notches 138, 139 formed therein into alignment with the locking blocks 135, 136, so that further rearward movement of both drive cables 131, 132 will cause the locking blocks to move into the notches 138, 139 (see FIG. 30C) due to the beveled surfaces of the locking blocks and the guide track recesses in which they are received. As a result, the two covers become coupled together so that further rearward movement to the FIG. 30D position will cause both covers to assume a position in which the rear cover 12 is raised at its rear edge and the front cover 10 is brought into a spoiler roof position cantilevered over the rear cover 12. Forward movement of the cables will produce a reverse of the movements described above.

As should be apparent, by appropriate, selective driving of one or both of the drive cables 131, 132, in one or the other forward and rearward directions, coupling and uncoupling of the connecting rods via the locking blocks can be produced in a manner so as to achieve selective opening and closing of the covers 10, 12 in various other manners.

Various other modifications can be made to the above described embodiments, For example, the drive for the covers and the drive for the shades can be coupled such that the covers can only be raised when the corresponding shade has been at least partially opened beforehand. Additionally, instead of using rollable shades to cover the covers, functionally equivalent sliding headliners can be used which are opened or closed in the same way.

This invention also makes it possible to eliminate the need for additional drive means by providing only two drives with still considerable user-friendliness, and especially installation space, guide tubes, electronic components and position sensors for control can be saved. Furthermore the viewing area through the roof can be enlarged.

What is claimed is:

1. Openable motor vehicle roof comprising a fixed roof with at least one roof opening, first and second transparent covers which are displaceable between positions closing and at least partially opening said at least one a roof opening, and first and second coverings underneath the first and second covers, respectively, said coverings being displaceable between a closed position masking the view out of the vehicle interior through a respective area of the at least one roof opening and at least one open position at least partially clearing the view out of the vehicle interior through the respective area of the at least one roof opening; wherein a first drive is provided for displacing both the first cover and the first covering; and wherein a second drive is provided for displacing both the second cover and the second covering.

2. Motor vehicle roof as claimed in claim 1, wherein the second covering is displaceable into a position completely withdrawn from under the respective area of the at least one roof opening by the second drive.

3. Motor vehicle roof as claimed in claim 2, wherein a rear edge of the second cover is raisable by a raising mechanism and the second covering is selectively openable and closable by the second drive when the second cover is in the closed position.

4. Motor vehicle roof as claimed in claim 3, wherein the second drive is adapted to open the second covering at least in part before raising the second cover, the first covering being held in an open position during raising of the second cover.

5. Motor vehicle roof as claimed in claim 4, wherein, with the second covering in an open position and before raising the second cover from a locked closed position, the second covering is adapted to be separated from the second drive and to be locked automatically in the open position, the locking of the second cover is automatically released and the second drive is automatically connected to the raising mechanism of the second cover in order to raise the second cover.

6. Motor vehicle roof as claimed in claim 5, wherein, upon returning the second cover to the closed position, a raising mechanism of the second cover is adapted to be automatically separated from the second drive and locked in the closed position and the second covering is adapted to be unlocked and connected to the second drive.

7. Motor vehicle roof as claimed in claim 1, wherein the first covering is adapted to be displaced depending on the position of the first cover.

8. Motor vehicle roof as claimed in claim 7, wherein the first cover is raisable at a rear edge thereof and the first drive is adapted to at least partially open the first covering by the raising motion of the first cover, and wherein the first drive is adapted to prevent manual closing of the first covering means with the first cover raised.

9. Motor vehicle roof as claimed in claim 8, wherein the first drive comprises at least one compressively stiff drive cable, and wherein the first covering is adapted to be at least partially opened by motion of a free end of the drive cable during raising of the first cover by the drive cable.

10. Motor vehicle roof as claimed in claim 8, further comprising a drive carriage connected to the first cover which is adapted to open the first covering at least in part by engagement therewith.

11. Motor vehicle roof as claimed claim 1, wherein the first cover is movable rearward by the first drive to clear the roof opening.

12. Motor vehicle roof as claimed in claim 11, wherein the first cover is adapted to entrain the first covering rearward into an open position and holds it there by a driver.

13. Motor vehicle roof as claimed in claim 12, wherein the first covering is manually displaceable when the first cover is closed.

14. Openable motor vehicle roof comprising a first cover and a second cover, each of which close a roof opening in a closed position thereof and are displaceable to clear the roof opening at least in part, a first covering underneath the first cover and a second covering underneath the second cover, said coverings being displaceable between a closed position masking the view out of the vehicle interior through a respective area of the roof opening and at least one open position at least partially clearing the view out of the vehicle interior through the respective area of the at least one roof opening; wherein a first drive is provided for displacing both the first cover and the second cover; and wherein a second drive is provided for displacing both the first covering and the second covering.

15. Motor vehicle roof as claimed in claim 14, wherein the first and the second cover are raisable at rear edge thereof.

16. Motor vehicle roof as claimed in claim 15, wherein the first and the second coverings are selectively openable and closable by the second drive when the first and the second cover are closed.

17. Motor vehicle roof as claimed in claim 16, wherein the first and the second covering are adapted to be opened at least in part by the second drive and held in this position before raising of the first and the second cover.

18. Motor vehicle roof as claimed in claim 17, wherein the first drive is adapted to first raise the first cover and then raise the second cover out of the closed position thereof, and is adapted to first close the second cover and then close the first cover from positions to which the covers have been raised.

19. Motor vehicle roof as claimed in claim 14, wherein the first cover is located in front of the second cover in a lengthwise direction of the motor vehicle.

20. Motor vehicle roof as claimed in claim 14, wherein the first and the second coverings are each made as a shade arrangement having a shade web which is windable onto a winding shaft.

21. Motor vehicle roof as claimed in claim 20, wherein each winding shaft is dynamically connected via cables to a deflection roller which is arranged parallel to the winding shaft.

22. Motor vehicle roof as claimed in claim 20, wherein the winding shafts are located in an area between the covers.

23. Motor vehicle roof as claimed in claim 21, wherein the winding shaft of the shade arrangement for the front cover is located in a front end area of the first cover and the winding shaft of the shade arrangement for the second cover is located in a back end area of the second cover.
